(19) United States
(12) Patent Application Publication
(10) Pub. No.: US 2008/0231462 A1
(43) Pub. Date: Sep. 25, 2008

(54) PROXIMITY-ACTIVATED LOCATION DETECTION SYSTEM

(76) Inventor: Harrison H. Hobart, Fountain Hills, AZ (US)

Correspondence Address: WEISS & MOY PC, 4204 NORTH BROWN AVENUE, SCOTTSDALE, AZ, 85251, US

(21) Appl. No.: 11/688,028

(22) Filed: Mar. 19, 2007

(51) Int. Cl. G08B 21/00

(52) U.S. Cl. 340/686.6; 340/573.4

(57) ABSTRACT

A proximity-activated location detection system is used for determining the geographic positions of one, or several locator hardware-sets. The system calculates the separation distance and time between the hardware-sets from each other, or from predetermined, fixed geographic positions, such as a residence, or workplace. Each of the locator hardware-sets within the proximity-activated location detection system consists of one portable wireless communication device that includes a transmitter and a receiver, one portable geographic locating device and one integration module assembly device. The integration module assembly contains the necessary hardware that interprets data from the geographic location device, calculates any necessary values, and sends messages using the wireless communication device. During operation, the locator hardware-sets may communicate with a central monitoring station and with each other. Each hardware-set is assigned a unique, identifying set-number allowing it to be associated with the person, or other entity.

### BACKGROUND OF INVENTION

1. Field of Invention

The present invention relates, generally, to location detection systems and, more specifically, to systems able to locate, track and monitor a user, or multiple users, using several location technologies, including the Global Positioning System (GPS).

2. Description of Related Art

Numerous types of location detection systems are known in the prior art. For example, U.S. Pat. No. 4,673,936, issued to K. Kotoh (1987); U.S. Pat. No. 5,043,736, issued to R. D. Damell, et al. (1991); U.S. Pat. No. 5,014,040, issued to P. W. Weaver et al. (1991); U.S. Pat. No. 5,731,757, issued to H. M. Layson, Jr. (1998); U.S. Pat. No. 5,841,396, issued to N. F. Krasner (1998); U.S. Pat. No. 6,014,080, issued to H. M. Layson (2000); U.S. Pat. No. 6,064,336, issued to N. F. Kranser (2000); U.S. Pat. No. 6,076,099, issued to T. C. H. Chen et al. (2000); U.S. Pat. No. 6,362,778, issued to T. J. Neher (2002); are all illustrative of such prior art. While these units may be suitable for the particular purpose to which they address, they would not be suitable for the purposes of the present invention as described herein.

In some prior art applications, the failure to perform a required act at a particular time is considered notice to a monitoring service that a user is not where they are expected. In those applications that depend upon a beacon, or other transmission, the lack of a transmission is considered a notice that the user is out of range of the receiving device, or the locator unit has been disabled. In these instances, the monitoring service will call a telephone number given them by the subscriber, and report a possible breech of a specified routine. A problem with this process is that the monitoring service does not have a positive indication of the problem. It only knows that something expected did not occur. This ambiguity and lack of clear remedy could result in a costly false alarm, or worse, lack of assistance to the person whose life may be in danger.

Prior art system applications may include one, or more of the hardware components described below. These descriptions are excerpted from a bulletin authored by the National Law Enforcement Corrections Technology Center dated October 1999 and entitled “Keeping Track of Electronic Monitoring.” These systems assume a hostile operating environment, in which, there is an offender who tolerates imposed rules to avoid being incarcerated and, a victim whose safety is the purpose of the imposed rules.

Home Monitoring Devices (HMD): These devices may be installed in an offender's home for use with a transmitter that the offender wears at all times. The HMD uses the offender's telephone line and jack and power from a 120 VAC outlet. If the offender moves out of range of the HMD, the HMD will call the monitoring service to report the condition. This arrangement has the disadvantage of preventing an offender from working, as many businesses would not welcome the installation of a HMD in their workplace. In some jurisdictions, part of the court order is that the offender will work and pay all or part of the cost of the monitoring service.

Transmitters for use with the HMD: These are wrist or ankle bracelets worn by the offender to send a beacon signal to the HMD. These devices are often equipped with latches, or locks that trigger an alert message to a monitoring service, or subscriber, or both should the wearer attempt to remove the device from their person. When the transmitter is within range, the HMD detects the signal and remains in a neutral mode. If the offender moves outside the transmitter range, the HMD changes to a breach-mode and calls the monitoring service. The monitoring service will take corrective action, usually by calling a responsible law enforcement agency. A typical application is house arrest. A disadvantage of this arrangement is the same as noted in the above paragraph. This arrangement has the disadvantage of preventing an offender from working, as many businesses would not welcome the installation of a HMD in their workplace. In some jurisdictions, part of the court order is that the offender will work and pay all or part of the cost of the monitoring service.

In domestic violence cases, a victim may have an HMD receiver installed in their residence. The offender is required to wear a transmitter. If the offender moves to be within the transmitter's range of the victim's HMD, it will detect the offender's transmitter, issue a warning signal for the victim, and call the monitoring service. The transmitter range is about 150 feet inside a building. If the victim and the offender are outside, the transmitter range can extend to 500 feet. The victim may also be given a pendant that emits a warning signal if it detects the offender's transmitter signal. The victim can activate the pendant device and cause the HMD receiver to call the monitoring service.

HMD systems are only marginally effective. When an HMD is installed in the victim's home, the victim is essentially a prisoner in his or her own home and the short warning range allows the offender to approach dangerously close before the alarm is activated.

Field Monitoring Devices (FMD): These are devices used to verity that an offender who is out in public is wearing a transmitter as required by a court order. These devices operate as the HMD, except they are mobile. The FMD is light and small, has a receiving range of about 100 feet and may be mounted on the roof of a patrol car. These devices allow officers, when they visually recognize an offender, to move within the offender's transmitter range and determine if the offender is wearing a required transmitter. A typical application is for persons on a work-release, or training program whose authorized movements are predetermined.

The FMD is only marginally effective. The offender is able to approach the victim's home, or place of work without warning the victim. Should the offender deviate from the authorized movements, it is unlikely that the officers using the FMD could locate the offender in a timely manner. For the victim, this is a high-risk system. For the offender, there is the inconvenience of having to wear a transmitter device when at his place of work, or job-training.

Alcohol Testing Devices: These devices are typically connected to an offender's HMD and telephone. Incarcerated offenders are prohibited from drinking alcohol. Therefore, any electronic monitoring programs also require testing to ensure that electronically monitored participants are not consuming alcohol. An alcohol sensor is attached to the offender's telephone. The testing is done at random times so the participants are not able to predict when the test will be made. There are several methods to determine that the correct person is breathing into the testing device. A common method is to use a voice verification device, as described below, just prior to administering the alcohol testing procedure. Should the offender fail the test, the HMD notifies the monitoring service. The monitoring service then notifies a monitoring service subscriber to take appropriate action.

Voice Verification Systems: A participant's voiceprint is stored in the monitoring agency's computer and identified to the individual. Offenders are required to call the monitoring agency at certain times, or may be prompted to call by pager. Should the test fail, it is common to allow a second test, as the voice verification device is sensitive to noise on the telephone line, or in the background, and can generate a false alarm. If the second test fails, then the case officer is notified immediately to take appropriate action. Voice verification testing is often used just prior to an alcohol test. This testing sequence improves the probability that the person taking the alcohol test is the correct individual.

Both the Alcohol Testing and the Voice Verification Systems are limited in their use as location detection systems. They both operate in concert with HMD devices and are subject to power and telephone failures. They also fall in the passive category, as the offender much act to initiate the tests.

Global Positioning System (GPS): In a typical application for domestic violence cases, a victim is given a cell phone, and in some instances, a pager. The offender is required to wear a portable GPS receiver and a portable transmitter, both of which are secured to the offender with locks that trigger an alert signal should the wearer attempt to remove the devices from their person. The GPS receiver translates the GPS satellite signal to determine the geographic location of the GPS receiver, and thus, the offender. The location information is fed by the GPS receiver to the portable transmitter and broadcast to a monitoring agency. The monitoring agency is able to track the perpetrator 24 hours/day with the GPS as long as the GPS receiver and transmitter are powered on, and at least three GPS satellites are within the antenna window of the GPS receiver.

The GPS receiver can be programmed to have exclusion, or hot zones. These zones are typically the victim's home and workplace. If the offender moves into a hot zone, the monitoring service detects the breach and will notify a law enforcement agency, or subscriber who will attempt to notify the victim. Inclusion zones, within which the offender must be, can also be programmed into the GPS receiver. If the offender moves outside the inclusion zone, the monitoring service notifies a law enforcement agency. The monitoring service may also call the victim's pager to ware that the offender has breached a zone, or zones.

In the prior art, the emphasis has been on keeping track of the offender's activities and geographic position. Little emphasis has been placed on keeping track of the victim. The result is that the offender can, in many cases, breach the restrictions and, with little or no warning, physically confront the victim before assistance is available.

Some prior art designs requires costly equipment, especially those systems that have elaborate designs to maximize battery life or require specially designed beacon transmitters and receivers.

The prior art which utilizes a central monitoring stations depends upon human beings to constantly view the monitoring screen displaying the location of the subject, or subjects of interest. Even momentary inattention can result in an unidentified breach of the safety envelope.

The prior art lacks two of the most important features of a fail-safe operation: redundancy of equipment and redundancy of communication and procedural methods. A single equipment failure may shut down the system and leave the victim subject to harm from the offender. The lack of communication could also be interpreted as evidence that the offender has tampered with the equipment, when that is not the case. This is another example of potentially dangerous ambiguity in prior art.

In addition to physical injury, the Bureau of Justice Statistics reports indicate that, on average, 1,444 women were murdered each year from 1990 to 1996 by their current or former intimate partners. A more detailed study of fatalities reported in the Findings and Recommendations from the Washington State Domestic Violence Fatality Review, (December 2004) by the Washington State Coalition Against Domestic Violence, also determined that most of the fatal injuries are delivered at close range by handgun or rifle (57%), knife (16%), hatchet/axe (1%), blows and kicks (3%), blunt weapon (9%), strangulation (11%), motor vehicle (3%). These statistics suggest that, given sufficient warning, the vast majority of victims could have found refuge, or help in time to protect themselves and their families.

The following statistics serve to briefly describe the context of domestic abuse in the United States:
1. Approximately 90% of the victims of domestic violence are women.
2. Every 9 seconds a woman is assaulted and beaten.
3. Every day, on average, 4 women are murdered by boyfriends, or husbands.
4. The number-one cause of women's injuries are abuse at home

The prior art provides, at best, minimal warning capabilities for victims, and when there is a notification to a victim, there are often delays due to relaying the warning through a third party (EMS), or by human error during the monitoring process.

Therefore, it would be desirable to provide a system and method to overcome the above problems.

### SUMMARY OF INVENTION

In accordance with one embodiment of the present invention, a proximity-activated location detection system is disclosed. The proximity-activated location detection system is used for determining the geographic position of one, or several locator hardware-sets. The system calculates the separation distance and time between the hardware-sets from each other, or from predetermined, fixed geographic positions, such as a residence, or workplace. Each of the locator hardware-sets within the proximity-activated location detection system consists of one portable wireless communication device that includes a transmitter and a receiver, one portable geographic locating device and one integration module assembly device. The integration module assembly contains the necessary hardware that interprets data from the geographic location device, calculates any necessary values, and sends messages using the wireless communication device. During operation, the locator hardware-sets may communicate with a central monitoring station and with each other. Each hardware-set is assigned a unique, identifying set-number allowing it to be associated with the person, or other entity.

### BRIEF DESCRIPTION OF DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a view of the front panel 23 and one side of an IMA 12, finger-grip depression 22, push-button switch number one 13, analog data input jack 16 and serial data input jack 19.

FIG. 2 is a view of battery cover 35 and one side of IMA 12 battery cover lock 31, circuit board panel finger grip 34, push-button switch number two 25 and analog data output jack 28.

FIG. 3 is a view of the base of IMA 12 showing multi-purpose electrical connection socket 37.

FIG. 4 is an exploded view of IMA 12.

FIG. 5 is an exploded view of IMA 12 showing various components from the side opposite as shown in FIG. 4.

FIG. 6 is a simplified block diagram of a multiple-unit hardware-set 142 and the electrical interconnections of a GPS receiver 133, IMA 12 and WCD 140.

FIG. 7 is a process flow diagram of a full-monitoring-cycle (FMC) as implemented in the proximity-activated location detection system 10 operating in the monitoring-service-mode, with two users.

FIG. 8 is an exemplary standard system-message-record.

FIG. 9 is a perspective view of the preferred process embodiment of proximity-activated location detection system 10 in the monitoring-service-mode, with two users.

FIG. 10 is an end view of a single-unit hardware embodiment 275A of the present invention illustrating external-input-end-cap 276 with battery-charging jacks 279 (+) and 282 (−), WCD external unit input-jack 285, GPS external unit antenna input-jack 288, GPS external unit input-jack 291 and WCD external unit antenna-input jack 294. Also illustrated are top-cover 297A, bottom-cover 300A, push-button-switch-one 303A and circuit-board-interconnecting-end-cap 306.

FIG. 11 is an end view of single-unit hardware embodiment 275A from the opposite direction as shown in FIG. 10 showing circuit-board interconnecting end-cap 306, top-cover 297A, bottom-cover 300A and push-button-switch-two 303B.

FIG. 12 illustrates hardware embodiment 275A with circuit-board interconnecting end-cap 306 removed to show placement of GPS circuit-board 309A, IMA circuit-board 312, battery circuit-board 315 and WCD circuit-board 317A.

FIG. 13 is a reverse view of end-cap-306 showing interconnection patch-plate 320.

FIG. 14 illustrates a second single-unit hardware embodiment 275B configured with GPS circuit-board 309B with display, and top-cover 297B with display viewing window.

FIG. 15 is a view of second hardware embodiment 275B rotated laterally 180 degrees to show the back-cover 300A.

FIG. 16 illustrates a third single-unit hardware embodiment 275C configured with WCD circuit-board 317B with a display, and bottom-cover 300B with display viewing window.

FIG. 17 is a view of a third single-unit hardware embodiment 275C rotated laterally 180 degrees to show top-cover 297A.

FIG. 18 illustrates a fourth single-unit hardware embodiment 275D configured with GPS circuit-board 309B with display, and top-cover 297B with display viewing window.

FIG. 19 is a view of fourth single-unit hardware embodiment 275D configured with WCD circuit-board 317B with display, and bottom-cover 300B with display viewing window.

FIG. 20 is an end view of a second multi-unit hardware embodiment 275E with external-connection end-cap 276 removed, for clarity, and GPS-circuit-board 309A removed. GPS receiver 133 is connected to external-connection end-cap 276 with GPS-interconnecting-cable 194.

FIG. 21 is an end view of a third multi-unit hardware embodiment 275F with end-cap 276 removed, for clarity, and WCD-circuit-board 317A removed. WCD-unit 140 is connected to end-cap 276 with WCD-interconnecting-cable 196.

FIG. 22 is an end view of a fourth multi-unit hardware embodiment 275G with end-cap 276, GPS-circuit-board 309A and WCD-circuit-board 317A removed. GPS receiver 133 is connected to end-cap 276 with GPS-interconnecting-cable 194. WCD unit 140 is connected to end-cap 276 with WCD-interconnecting-cable 196.

FIG. 23 illustrates a basic, multi-unit hardware-set 142 using cable 194 to connect GPS-receiver 133 and cable 196 to connect WCD-unit 140 to IMA 12.

FIG. 24 illustrates a second process embodiment of the system 10 with user 1's direct communication link 175 to EMS 172 removed.

FIG. 25 shows a third process embodiment of the system 10 with user 1's WAAS transmission data 130 removed.

FIG. 26 is a fourth process embodiment of the system 10 with user 1's WAAS transmission 130 and user 1's direct link 175 to EMS 172 removed.

FIG. 27 illustrates a fifth process embodiment of the system 10 with user 1's secondary monitoring devices 163 and communications link 160 to EMS 172 removed.

FIG. 28 illustrates a sixth process embodiment of system 10 with user 1's secondary monitoring devices 163, user 1's communications link 160 to EMS 172 and user 1's direct link 175 to EMS 172 removed.

FIG. 29 illustrates a seventh process embodiment of system 10 with user 1's WAAS transmission 130, user 1's secondary monitoring devices 163 and communications link 160 removed.

FIG. 30 is an eighth process embodiment of the system 10 with user 1's WAAS transmissions 130, secondary monitoring devices 163, communications link 160 and direct EMS link 175 removed.

FIG. 31 is a second process flow diagram of system 10 operating in a multiple-hardware-sets-mode, with two users and no EMS 172.

Each user may have one of the several hardware embodiments and one of the several process embodiments at any given time, as determined by subscribers 154.

### DETAILED DESCRIPTION

Turning now descriptively to the drawings, in which similar reference characters denote similar elements throughout the several views, the Figures illustrate the proximity-activated location detection system of the present invention, indicated generally by the numeral 10.

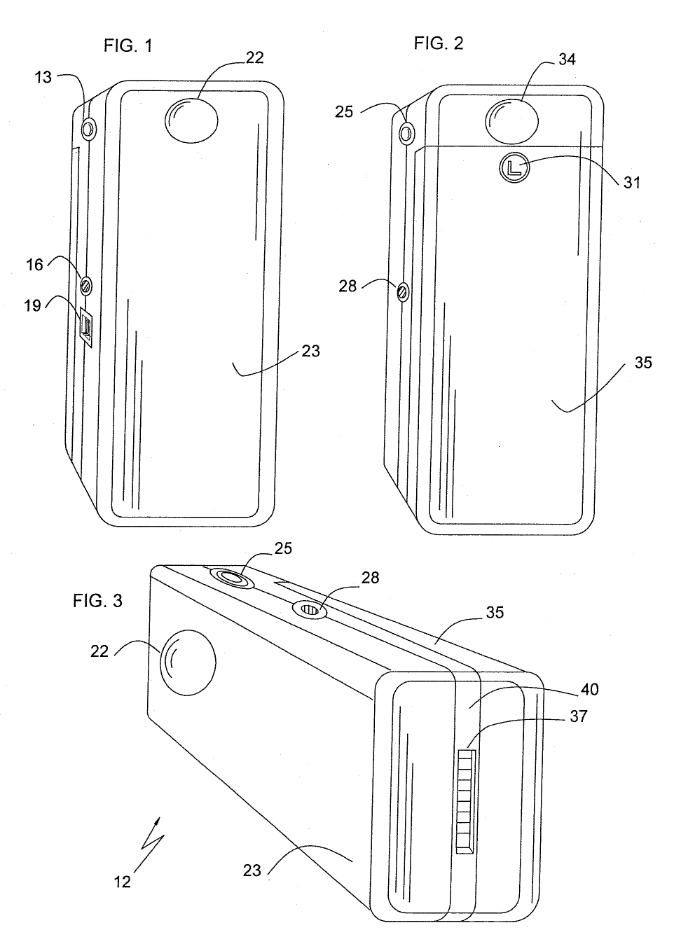

An exemplary embodiment of integration module assembly (IMA) 12 is illustrated in FIGS. 1, 2, and 3. The main structural components of the IMA 12 include a front panel 23, circuit board panel 40, and battery cover 35 which are constructed of tough, durable plastic as commonly used for portable telephones. Other materials may be used without departing from the spirit and scope of the present invention. The front panel 23 is secured to a circuit board panel 40. The size of the IMA 12 is comparable to a cellular telephone. However, this should not be seen as to limit the scope of the present invention.

FIG. 1 is a perspective view showing the front panel 23 with front panel finger grip depression 22, push-button switch number one 13, analog data input jack 16 and serial data input jack 19. FIG. 2 is a perspective view showing battery cover 35 with battery cover lock 31, circuit board panel with circuit board panel finger-grip-depression 34, push-button switch number two 25 and analog data output jack 28. FIG. 3 is a perspective end view showing circuit board panel multi-purpose electrical socket 37, battery cover 35, circuit board panel 40, analog data output jack 28, push-button switch number two 25, front panel 23 and front panel finger-grip-depression 22.

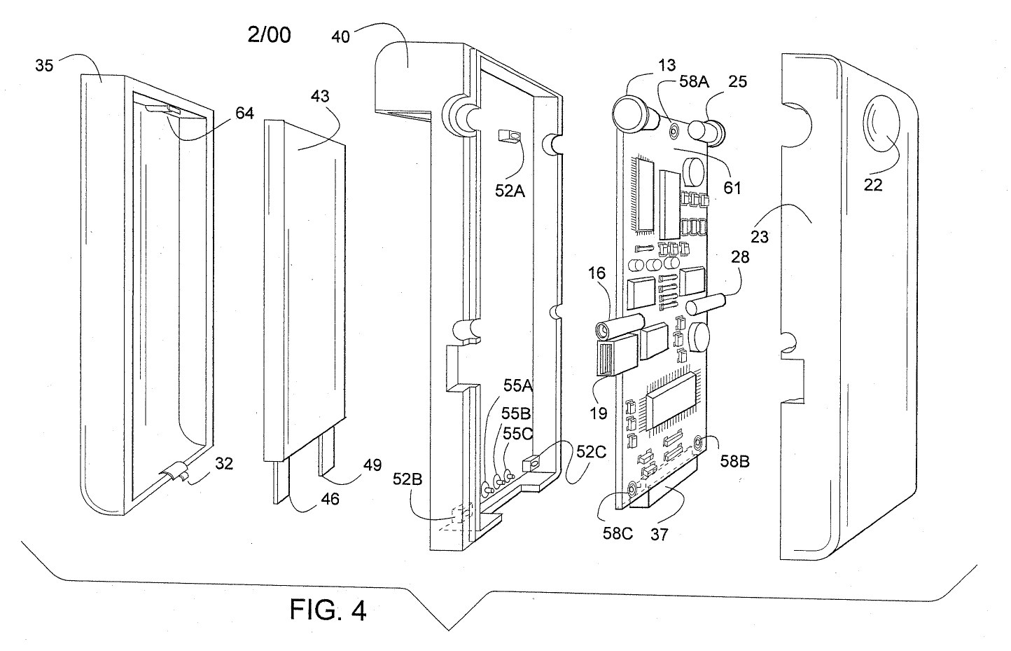

FIG. 4 is an exploded view of IMA 12. In this figure, battery cover latch 64 is shown with long-life battery 43, positive blade electrical contact 46 and negative blade electrical contact 49. Circuit board panel 40 has three circuit board mounting stand-offs, 52A, 52B and 52C. Circuit board 61 is secured to the panel's 40 stand-offs 52A, 52B, 52C through circuit board grounding holes 58A, 58B, and 58C. The panel 40 houses three spring-loaded electrical contacts 55A, 55B and 55C. Battery power is applied to circuit board 61 via contacts 55A and 55C. Also shown included with the circuit board 61 are push-button switches one 13 and two 25, multi-purpose electrical socket 37, analog data output jack 28, analog data input jack 16 and serial data input jack 19. Contact 55B is connected to circuitry of circuit board 61. Battery cover 35 is secured to circuit board panel 40 using battery cover latch 64, battery cover bottom catch 32 and, as shown in FIG. 2, battery cover lock and battery cover bottom slot.

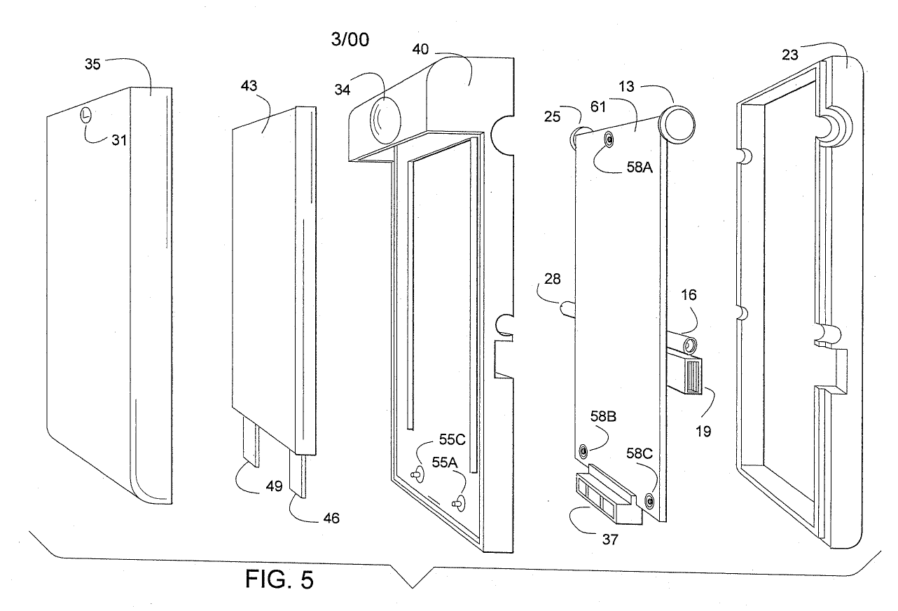

FIG. 5 is an exploded view of IMA 12 from the opposite vantage point used in FIG. 4, showing reverse sides of panels 23, 40, and 35 and reverse sides of battery 43 and circuit board 61. Shown on the battery cover 35 is the battery cover lock 31. Also shown are the electrical contacts 46, 49 at the bottom of the battery 43. Displayed on the opposite side of the circuit board panel 40 are two of the spring loaded electrical contacts 55A, 55C. Furthermore, the reverse side of the circuit board 61 is shown with the push buttons 13, 25 at each top end, the analog data input jack 16 and analog data output jack 28 at each side, and the serial data input jack 19 on the same side as the analog data input jack 16. Finally, the multi-purpose electrical socket 37 is secured to circuit board 61 at the bottom along with two grounding holes 58B, 58C. An additional ground hole 58A is located at the top of the circuit board 61.

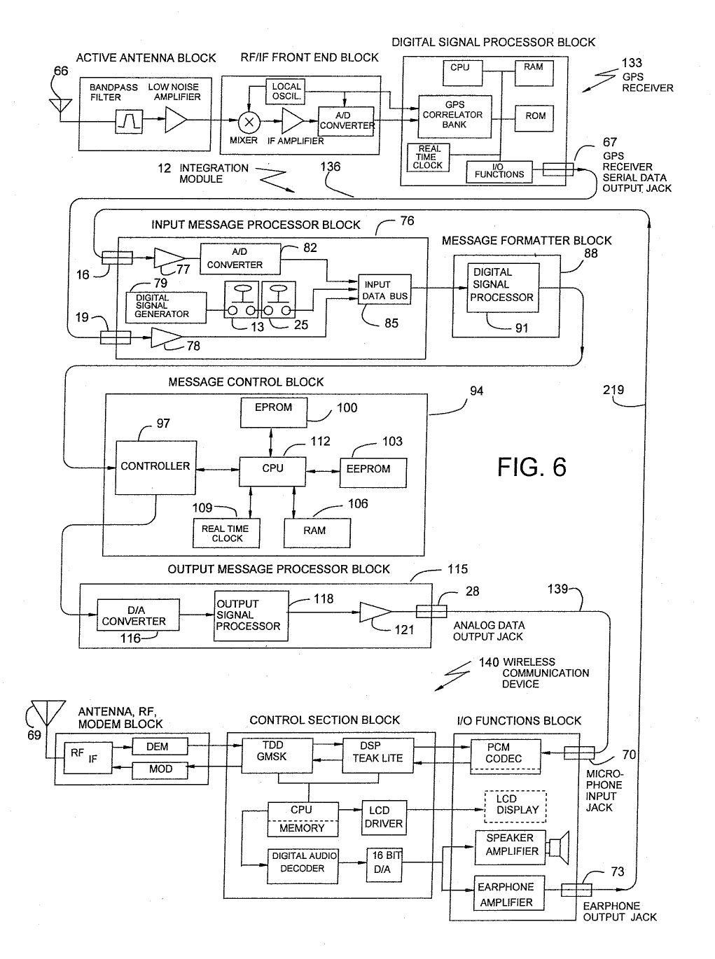

FIG. 6 is a simplified block diagram of a hardware-set 142. A hardware-set 142 consists of one IMA 12, one GPS receiver 133 with antenna 66, one wireless communication device (WCD) 140 with antenna 69. WAAS-corrected PVT input 136 (hardware-set 142 position data) to IMA 12 is routed from GPS receiver 133 serial data output jack 67 via interconnecting cable to IMA 12 serial data input jack 19. Analog PVT or system message inputs 219 to IMA 12 are routed from WCD 140 earphone data output jack 73, via interconnecting cable, to IMA 12 input jack 16. Analog PVT or system message outputs 139 (IMA 12 transmission) are routed from IMA 12 analog data output jack 28 to WCD 140 microphone input jack 70 via interconnecting cable.

Input message processor block 76 consists of analog input amplifier 77, A/D converter 82, serial input amplifier 78, digital signal generator 79, push-button switch number one 13, push-button switch number two 25 and input data bus 85.

Message formatter block 88 consists of digital signal processor 91.

Message control block 94 consists of controller 97, EPROM 100, EEPROM 103, RAM 106, real-time clock 109 and CPU 112.

Output message processor block 115 consists of D/A converter 116, output signal processor 118, and output amplifier 121.

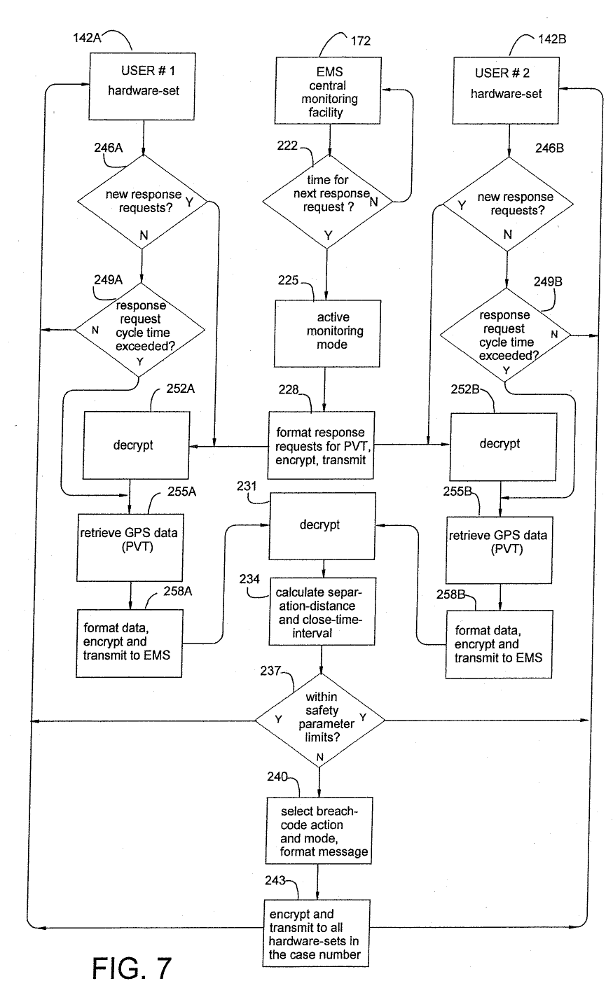

FIG. 7 is a process-flow diagram illustrating the logical and action blocks required to complete a full-monitoring-cycle (FMC) and the data exchange between EMS 172 and user 1's hardware-set 142A and the data exchange between user 2's 191 hardware-set 142B. The process is described in the following section.

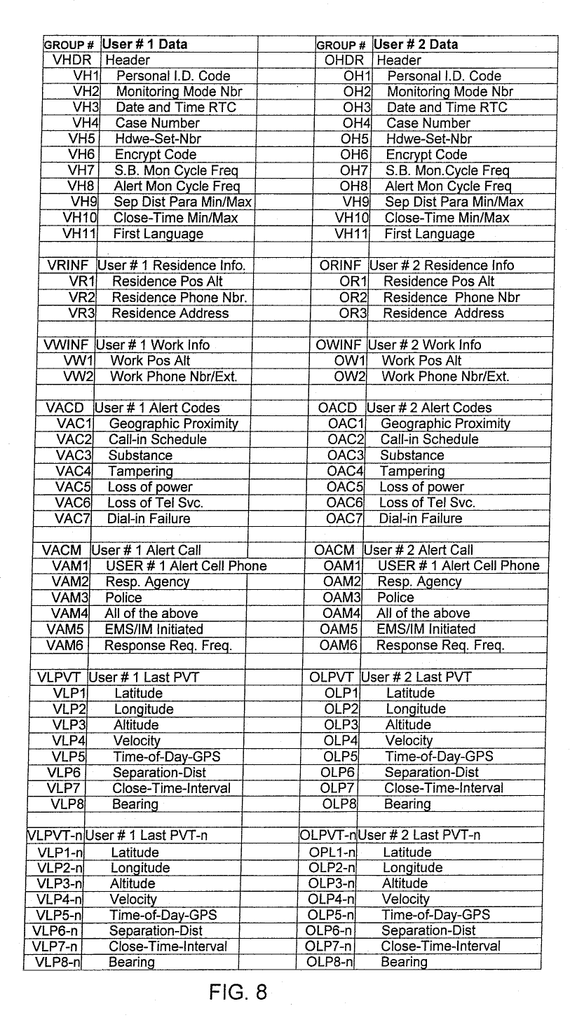

FIG. 8 is an exemplary system-generated message record. The fields of the system-generated message will also be described later.

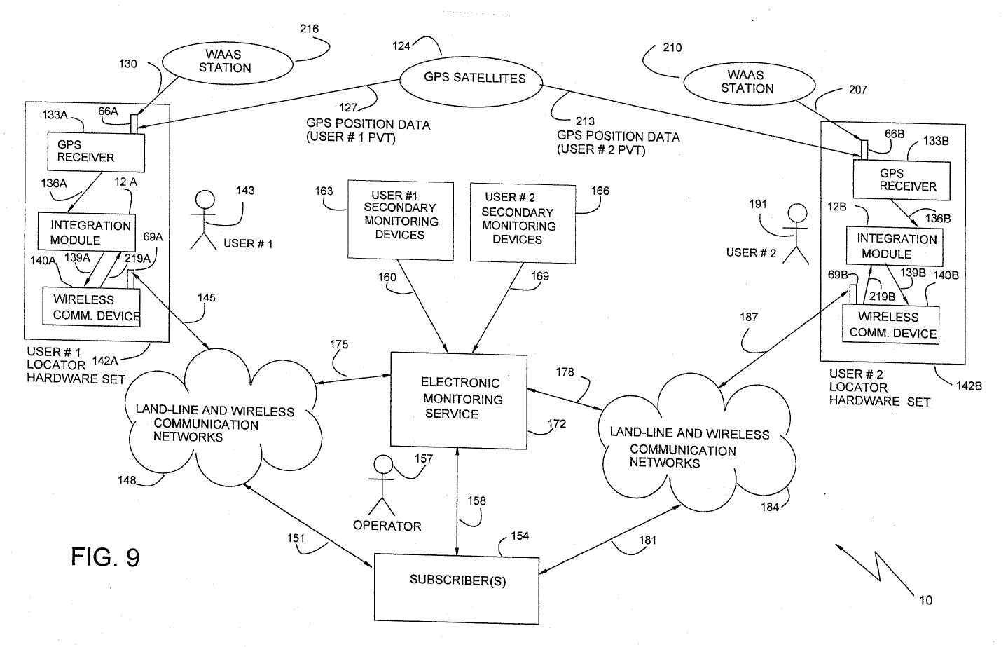

FIG. 9 illustrates the proximity-activated location detection system 10 in a perspective view. System 10 includes electronic monitoring service (EMS) 172, EMS operator 157, GPS tracking satellites 124, WAAS station 216, and WAAS station 210. Locator hardware sets 142A and 142B are portable units carried by user 1 143 and user 2 191, respectively. Communication between EMS 172 and user 1's 143 locator hardware-set 142A and user 2's 191 locator hardware-set 142B is accomplished via communications networks 148 and 184, respectively. User 1's 143 corrected PVT data 136A and user 2's 191 corrected PVT data 136B are processed by user 1's 143 IMA 12A and user 2's 191 IMA 12B, respectively, into user 1's 143 formatted PVT data 139A and user 2's 191 formatted PVT data 139B. User 1's 143 system messages 145 are received via antenna 69A of user 1's WCD 140A and passed as user 1's 143 formatted system messages 219A to user 1's IMA 12A. User 2's 191 system messages 187 are received via antenna 69B of user 2's WCD 140B and passed as user 2's 191 formatted system messages 219B to user 2's IMA 12B.

User 1's 143 secondary monitoring devices 163 and user 2's 191 secondary monitoring devices 166 include any location detection, home monitoring, alcohol detection devices installed in, or used in either user 1's 143, or user 2's 191 residence, or other geographic location. System message transmissions 160 and 169 from those devices to EMS 172 may be forwarded to other destinations via communication links 145, 175, 151, 187, 178 and 181.

Global Positioning System (GPS) satellites 124 provide geographic position data 127 and 213, respectively to user 1's 143 GPS receiver 133A and user 2's 191 receiver 133B via antennas 66A and 66B, respectively.

Wide Area Augmentation System (WAAS) is a system of geostationary satellites and a multiplicity of ground stations. WAAS ground stations 216 and 210 provide GPS signal corrections 130 and 207, respectively, to user 1's 143 and user 2's 191 GPS position, velocity and time (PVT) data 127 and 213, respectively.

System messages 158 between EMS 172 and subscriber 154 are transmitted using dedicated lines and numbers. Communication of user 1's 143 related messages 145 and 175 may be configured with dedicated lines, or numbers, as deemed appropriate by subscriber 154 and EMS 172. Communication of user 2's 191 related system messages 178 and 187 may be configured with dedicated lines, or numbers, as deemed appropriate by subscriber 154 and EMS 172.

Wired and wireless communications networks (COMNET) 148 and COMNET 184 are combinations of land-line and wireless communication systems, including the internet. COMNET 148 supports communications to and from user 1's 143 locator hardware-set 142A, EMS 172, EMS operator 157 and subscriber 154. COMNET 184 supports communications to and from user 2's 191 locator hardware-set 142B, EMS 172, EMS operator 157 and subscriber 154.

Operation of proximity-activated location detection system 10 is described with reference to FIGS. 6, 7, 8 and 9.

FIG. 9 illustrates high-level, functional components and communication paths of system 10. Primary functions of system 10 are to determine and track the geographic locations of user 1 143 and user 2 191, and to periodically calculate a separation-distance between a user 1 143 and user 2 191. In addition, a close-time interval is calculated. Acceptable separation-distance and close-time interval are predetermined by subscriber 154 and EMS 172, based on the nature of each monitoring case.

When separation-distance and close-time interval have been determined, those values are compared to predetermined acceptable parameters stored in the system. If the calculated separation-distance and close-time interval are within the parameters, the system 10 remains in standby mode.

Completion of a full monitoring-cycle is required to acquire the necessary location data, with which to calculate a separation-distance between user 1 143 and user 2 191. The minimum data is the latitude and longitude of both user 1 143 and user 2 191, acquired within a narrow, elapsed-time interval.

Calculation of a close-time interval generally requires at least two full monitoring cycles to enable a time differential between successive monitoring cycles to be calculated, by evaluating the time lapse and separation-distance in stored standard system records FIG. 8.

FIG. 7 illustrates a full monitoring-cycle (FMC) logical process as implemented in Monitoring-Service-Mode. Rectangular figures represent an object, a person, or actions. Diamond shaped figures represent logical, binary decisions of either true, or not-true, based on the system's 10 state.

EMS 172 enters an active monitoring mode by determining the time-lapse 222 since the last response request was issued by EMS 172, and the current time, as determined from EMS's system clock. If the state is true, EMS 172 enters active monitoring mode 225. EMS 172 then performs actions as illustrated in action block 228 by formatting a standard response-request message, encrypting the request data and transmitting the request to all hardware-sets within a specified case number.

Each hardware-set 142A and 142B, receives the response request and performs actions 252A and 252B, respectively, decrypting the request. Each hardware-set retrieves its PVT data as shown in action blocks 255A and 255B. The PVT data is used to format a standard system record FIG. 8. Sets 142A and 142B perform action block 258A and 258B, respectively, encrypting the data and transmitting the data to EMS 172.

EMS 172 performs action block 234 calculating separation-distance and close-time interval. EMS 172 performs logic block 237 comparing the separation-distance and the close-time interval with predetermined parameter values stored in its system to determine if both are within acceptable limits. If they are, a completed standard system record FIG. 8 is transmitted to all hardware sets within the case number.

If either or both figures are not within acceptable limits, EMS 172 performs action block 240 selecting a breach code action and mode and formatting a standard system record FIG. 8. EMS 172 then performs action block 243 encrypting and transmitting the completed record to all hardware sets within the case number.

Each hardware-set, 142A and 142B periodically performs logic block 246A and 246B, respectively, to determine if there have been any new response requests. If there have been new requests, the hardware-sets perform action blocks 252A and 252B, respectively, and continue processing as described above.

If there have not been new response requests, each hardware-set performs logic block 249A and 249B, respectively, to determine if the response-request-cycle-time parameter has been exceeded. If it has not been exceeded the hardware sets remain in standby mode. If the response-request-cycle-time parameter has been exceeded, it is assumed that a response request from EMS 172 has not been issued, or was not received by the hardware-sets. Then, the hardware-sets perform action blocks 255A and 255B, respectively and the process repeats as described earlier.

FMC standby-repetition-rate is a parameter value predetermined by subscriber and EMS, and is defined as the time interval between the completion of the last full monitoring-cycle and initiation of the next cycle, when the system is in standby mode.

FMC alert-repetition-rate is also a parameter value predetermined for the system when it is operating in an alert mode. This repetition rate is higher than the standby repetition rate. The shorter time interval results in denser sampling, allowing the system to more precisely track user 1 and user 2.

Referring to FIG. 9, Close-time-interval is calculated, based on user 1's 143 formatted PVT data 139A, and user 2's 191 formatted PVT data 139B. Close-time-interval is defined as the time it will take for user 1 143 and user 2 191 to engage, if they travel at the same respective velocities, as last recorded by GPS system satellites 124. EMS 172 analyzes the results of these calculations, compares the results with the safety parameters of separation-distance and close-time-interval, pre-determined by the subscriber 154. If the values calculated fall outside the acceptable parameters, EMS 172 takes appropriate action as pre-determined by subscriber 154.

FIG. 9 also illustrates the overall operation of proximity-activated location detection system 10. Although user 1's 143 and user 2's 191 hardware-sets 142A and 142B, respectively, may be electronically configured differently, their circuitry and interconnections are identical

Antenna 66A of GPS receiver 133A receives PVT data 127 from GPS satellites 124, and, optionally, WAAS correction data 130 from WAAS station 216. PVT data 127 is processed by GPS receiver's 133A circuitry that converts the satellite's 124 latitude and longitude into the latitude, longitude and velocity of the GPS receiver 133A. The time of day of transmission of position and velocity data are also converted by GPS receiver 133A. Converted PVT data 136A is passed to IMA 12A's serial data input jack 19. Victim's PVT or message data 145 transmitted to hardware-set 142A by EMS 172 is received by WCD 140A via antenna 69A. PVT or message data 145 is processed by WCD 140A's circuitry and is available as WCD system messages 219A at earphone output jack 73 where it is passed to IMA 12A's analog input jack 16.

Referring to FIG. 6, the internal workings of the IMA 12A is shown. IMA 12A's input message processor block 76 routes message data through amplifier 77 and A/D converter 82 to input data bus 85. Should a user depress IMA 12A's push-button switches, simultaneously, a signal from digital signal generator 79 is routed to the input data bus 85.

All data from IMA 12A's input processor block 76 is routed to digital signal processor 91 of message formatter block 88. This process formats a standard system-message-record FIG. 8 with a standard header-section, based on hardware-set 142A's unique hardware-set-number, case number, PVT data and alert message, if present. The standard system-message-record FIG. 8 is routed to message control block 94 where controller 97 retrieves the time-of-day from real-time-clock 109 and directs CPU 112 to retrieve identifying case number, and personal data about the person to whom hardware-set 142A is assigned from EPROM 100. Variable parameter data is retrieved from EEPROM 103 and written to the message record. RAM 106 is used as working storage for CPU 112 in preparation for calculation of separation-distance and close-time-interval.

Standard system-message-record FIG. 8 is routed to output message processor block 115 in digital format. D/A converter 116 converts the digital message record to analog format. Output signal processor 118 builds the message record in its final form prior to amplification by amplifier 121. Analog output record is routed through output jack 28 to microphone input jack 70 of WCD 140A. WCD 140A's input circuitry prepares the analog input data for WCD 140A's control section where it is prepared for modulation and for transmission via antenna 69A to EMS.

Referring back to FIG. 9, user 2's locator hardware-set 142B consists of one GPS receiver 133B, one specially programmed and configured IMA 12B and WCD 140B, such as a cellular telephone, personal digital assistant, or satellite telephone. GPS receiver 133B receives GPS position data 213 and WAAS correction data 207 through antenna 66B. Receiver 133B processes GPS position data 213 and WAAS correction data 207, if present, passing PVT data 136B, to IMA 12B where it is processed into formatted offender's data 139B, and passed to WCD 140B for transmission via antenna 69B, to EMS 172.

EMS 172 combines user 1's 143 formatted PVT data 139A and user 2's 191 formatted PVT data 139B into a single, standard-message record FIG. 8. EMS 172 then uses user 1's 143 formatted PVT data 139A, and user 2's 191 formatted PVT data 139B, to calculate separation-distance between user 1 143 and user 2 191.

There are several formulae for calculating the distance between two points, given the latitude and longitude of each point. Three commonly used formulae are the Haversine, Spherical Law of Cosines and Vincenty. The Vincenty formula accounts for the ellipsoidal shape of the earth and is the most accurate of the three.

EMS 172 also calculates close-time-interval, based on separation-distance and the respective velocities of user 1 143 and user 2 191. EMS 172 compares separation-distance and close-time-interval with predetermined acceptable parameters and takes appropriate action as illustrated in FIG. 7 action block 234, logic block 237 and action blocks 240 and 243 if parameter limits have been exceeded. EMS 172 formats a standard system record FIG. 8 that contains user 1's 143 PVT data 139, user 2's 191 PVT data 193, separation-distance, close-time-interval, and stores combined system record FIG. 8 for its own history. EMS 172 transmits a copy of combined system record FIG. 8 to user 1's 143 WCD 140A, and to user 2's 191 WCD 140B. User 1's 143 WCD 140A passes user 1's 143 WCD system message 219A to user 1's 143 IMA 12A where it is stored in EEPROM 103 in the IMA 12A. User 2's 191 WCD 140B passes user 2's 191 WCD system message 219B to user 2's 191 IMA 12B where it is stored in EEPROM 103 in its local IMA 12B.

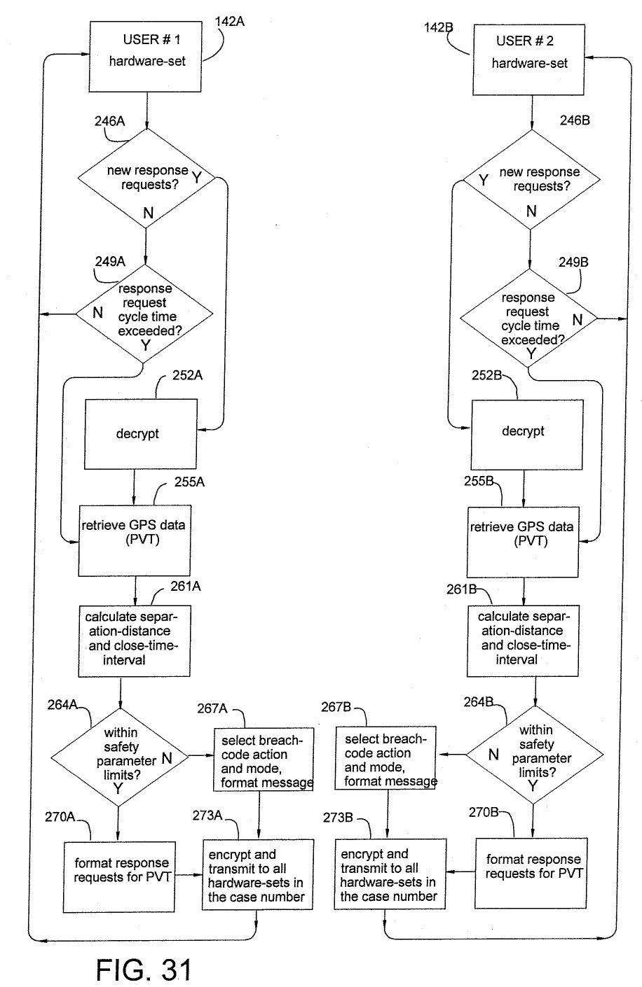

FIG. 31 illustrates a full-monitoring-cycle logical process flow when the system 10 is operating in the Multiple-Hardware-Sets mode. Each hardware-set, 142A and 142B periodically performs logic block 246A and 246B, respectively, to determine if there have been any new response requests. If there have been new requests, the hardware-sets perform action blocks 252A and 252B, respectively, and continue processing as described above.

If there are no new response requests, each hardware-set performs logic block 249A and 249B, respectively, to determine if the response-request-cycle-time parameter has been exceeded. If it has not been exceeded, the hardware-sets remain in standby mode. If the response-request-cycle-time parameter has been exceeded, hardware-sets 142A and 142B perform action blocks 255A and 255B to retrieve their respective GPS location data.

Next, hardware-sets 142A and 142B perform action block 261A and 261B, respectively, calculating separation-distance and close-time interval. Calculation results are passed to logic block 264A and 264B, respectively, where acceptable parameter limits are used to determine the current status. If it is determined that limits have been exceeded, separation-distance and close-time-interval are processed by action block 267A and 267B, respectively. Results of that process are passed to action block 273A and 273B for encryption and transmission to all hardware-sets in the case number. The system subscriber is also notified of the alert status and the location of both hardware-sets.

If acceptable limits have not been exceeded, a response request is formatted by action block 270A and 270B, respectively and passed to action block 273A and 273B, respectively for encryption and transmission to all hardware-sets in the case number. Upon completion of action blocks 273A and 273B, the system 10 resumes monitoring at the predetermined standby monitoring rate.

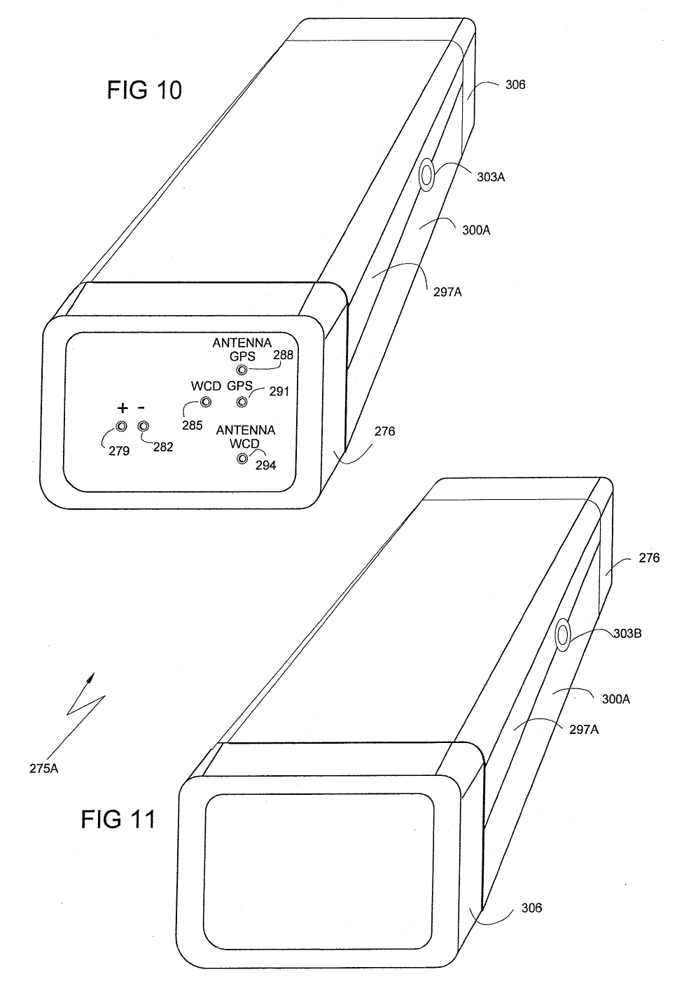

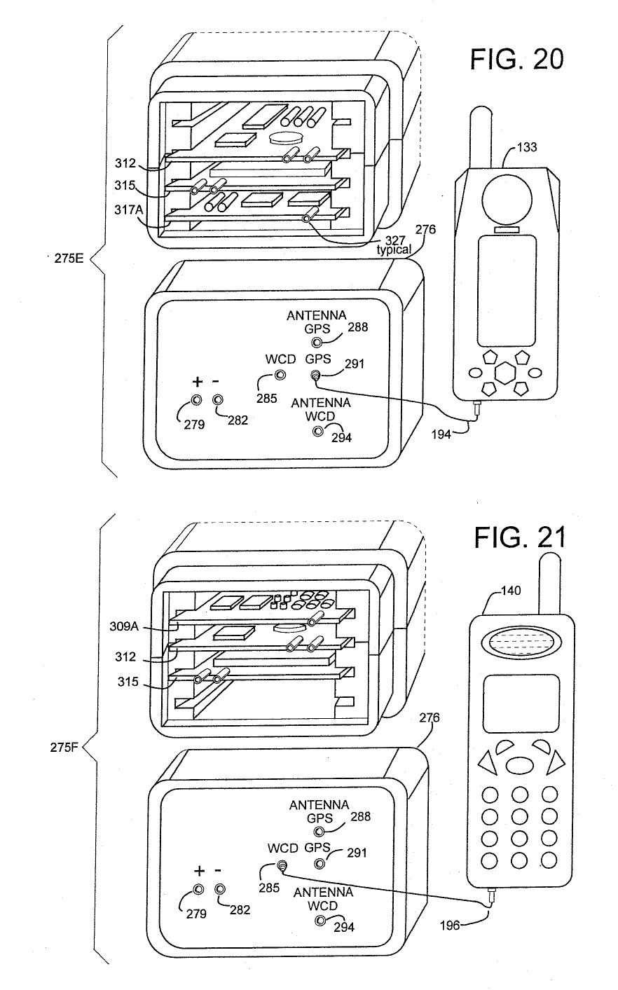

Alternative hardware embodiments may be used. Alternative hardware embodiments are generally of two varieties, multi-unit and single-unit configurations. FIGS. 10-19 illustrate single unit embodiments; FIGS. 20-23 illustrate multiple unit hardware embodiments.

Unless otherwise specified, all alternate hardware embodiments support basic system 10 functions.

FIG. 10 is an end view of a basic, single-unit embodiment 275A showing external unit input end-cap 276, top cover 297A, bottom cover 300A pushbutton switch one 303A, and circuit board interconnection end-cap 306.

Positive input battery charging input jack 279 and negative input charging jack 282, GPS external antenna input jack 288, WCD external input jack 285, GPS receiver external input jack 291 and WCD external antenna input jack 294 are contained in end cap 276.

FIG. 11 is an end view of single-unit 275A from the opposite vantage point as FIG. 10 illustrating the circuit board interconnection end-cap 306, external unit input end-cap 276, top cover 297A, and bottom cover 300A. Also shown is the opposite pushbutton switch 303B.

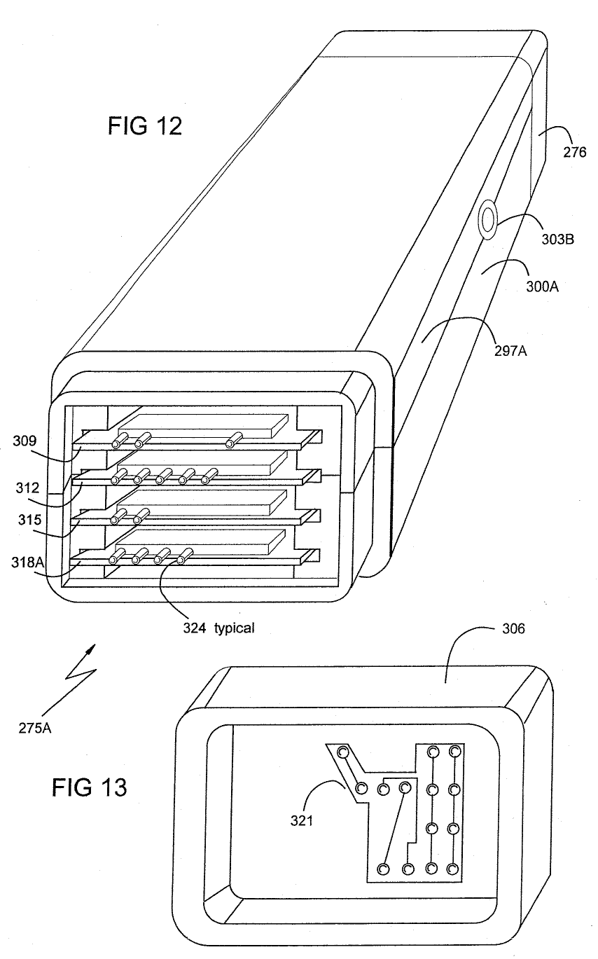

FIG. 12 is an end view of single-unit 275A with interconnection end-cap removed. GPS circuit board 309, IMA circuit board 312, battery circuit board 315 and WCD circuit board 318A are shown installed with circuit board connector plugs 324.

FIG. 13 is a view of end-cap 306 showing circuit board interconnection patch-plate 321 with inter-connection jacks that mate with the circuit boards' plugs shown in FIG. 12.

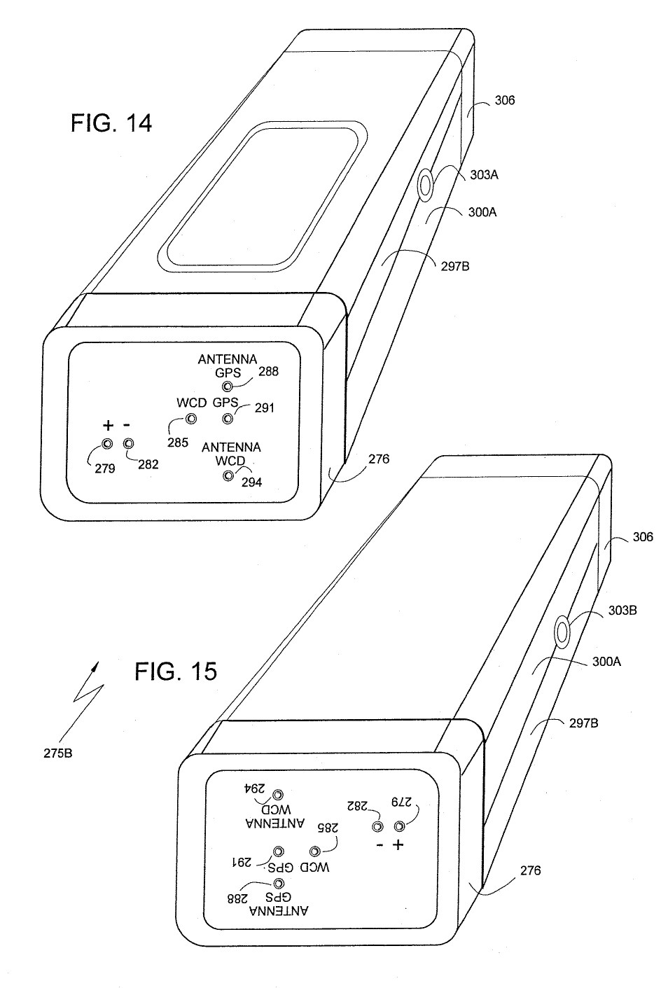

FIG. 14 is a view of a second single-unit embodiment 275B with top-cover 297B showing GPS display window. GPS circuit board with display is installed with this second embodiment. The external unit input end-cap 276, bottom cover 300A pushbutton switch one 303A, and circuit board interconnection end-cap 306 are also shown.

On the input end-cap 276, the positive input battery charging input jack 279 and negative input charging jack 282, GPS external antenna input jack 288, WCD external input jack 285, GPS receiver external input jack 291 and WCD external antenna input jack 294 are similar to those as of the embodiment illustrated in FIG. 10.

FIG. 15 shows second embodiment 275B rotated laterally. This embodiment differs electronically from 275A to the extent that a GPS display unit and associated circuitry are incorporated into GPS circuit board 309B. Also shown in FIG. 15 is the opposing push button 303B in addition to the components listed in FIG. 14.

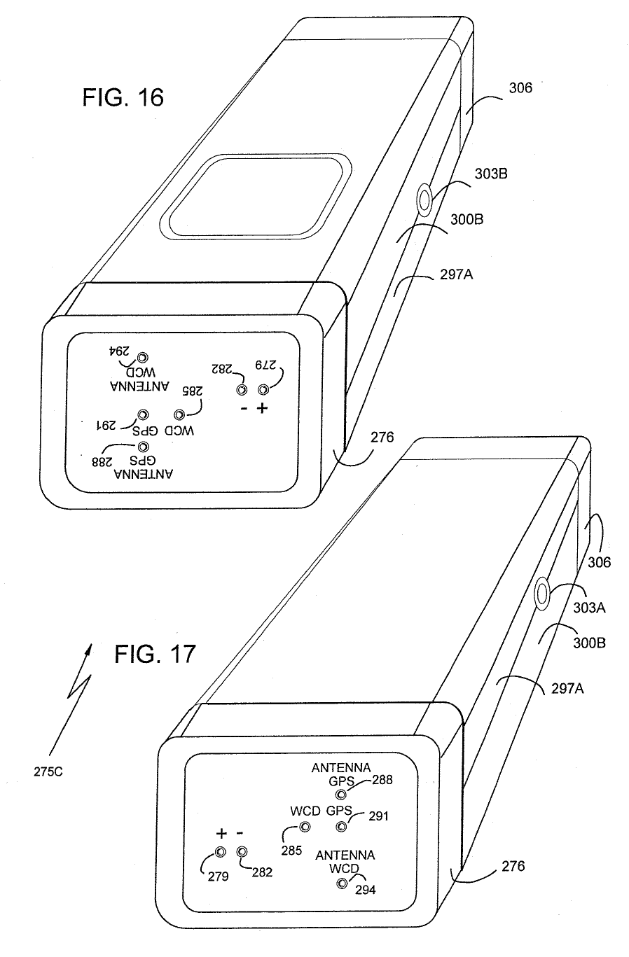

FIG. 16 is a bottom view of a third single-unit embodiment 275C showing bottom cover 300B with WCD display window. WCD circuit board 318B is installed with this third embodiment. FIG. 17 shows third embodiment 275C rotated laterally showing the opposite pushbutton 303A.

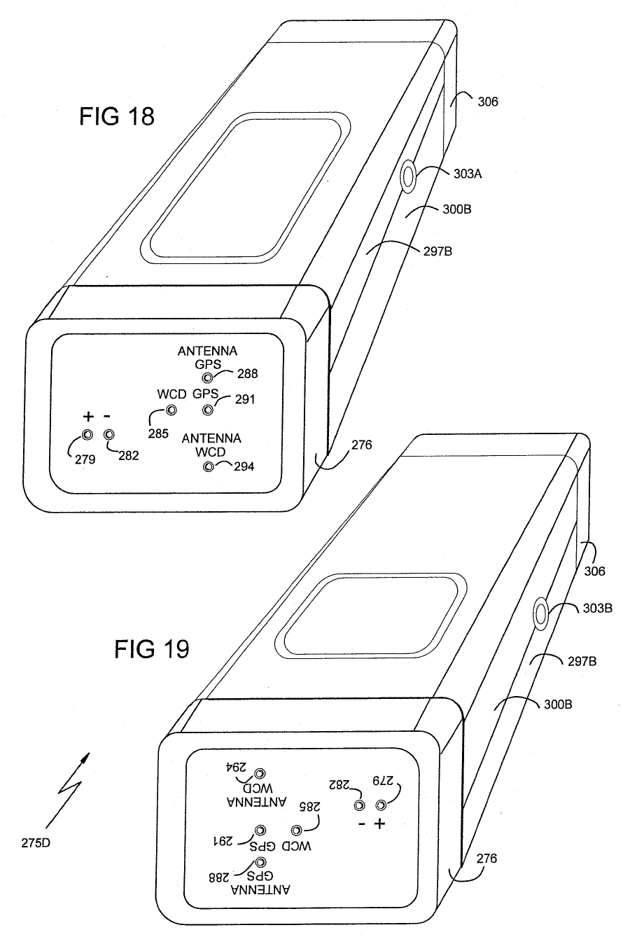

FIGS. 18 and 19 are end views of a fourth single-unit embodiment 275D, that is configured with both a GPS display and a WCD display.

FIG. 20 illustrates a multi-unit embodiment 275E showing GPS circuit board removed and GPS receiver unit 133 connected to end cap's 276 GPS input jack 291 with GPS interconnecting cable 194.

FIG. 21 shows a second multi-unit embodiment 275F with WCD circuit board removed and WCD 140 connected to WCD input circuit jack 285 with WCD interconnecting cable 196.

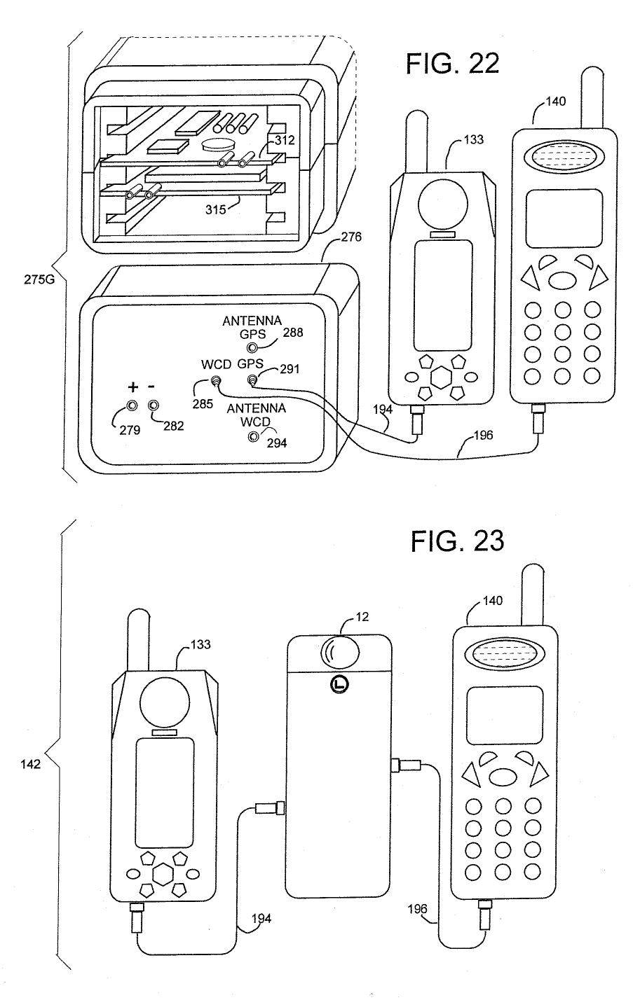

FIG. 22 is a third multi-unit embodiment with GPS circuit board and WCD circuit board removed, and GPS receiver 133 and WCD 140 connected to end cap input jacks 291 and 285 with cables 194 and 196, respectively.

FIG. 23 is a fourth multi-unit embodiment 142. It illustrates GPS receiver 133 and WCD 140, connected to IMA 12 with interconnection cables 194 and 196.

Additional hardware embodiments include hardware-carrying devices affixed to tamper-proof bracelets, or anklets. The bracelet or anklet is connected to IMA 12's circuitry via multi-purpose socket 37 or to circuit board 315 circuitry via input jack 282 such that removal or damage to the carrying device will trigger an alert message to an EMS, or other entity. This type embodiment is typically used in hostile environments, and is worn by an offender.

Additional hardware embodiments include the use of external antennae for GPS receiver unit 133 and WCD unit 140. External antennae are also accommodated with the external input end cap 276. A typical use for these embodiments is for areas where transmission and reception of GPS or WCD signals are less than optimal.

FIGS. 7 and 9 describe the preferred embodiments for system 10's process logic and process flow, respectively. FIG. 8 describes standard system record and header-record VHDR and OHDR operating parameter data groups. Alternates to preferred embodiments allow system 10 to operate without hampering the basic functionality, but detailed logic processes differ from the preferred embodiments, as described in the following paragraphs.

If subscriber 154 has set operating mode parameter to mode 3, monitoring-service-mode, system 10 will use process logic as shown in FIG. 7. Should a hardware failure or communications interruption occur, system 10 will default to multiple-hardware-sets-mode 2. When system 10 recognizes, from an answer to a response request, that EMS 172 is again part of the process, it will revert to the original monitoring-service-mode 3.

In the instance where system 10 operating mode has been set, by subscriber 154, or by system logic, as described above, to multiple-hardware-sets-mode 2, process logic, as described by FIG. 31 will be used. If a hardware or communications failure occurs, system 10 will default to stand-alone mode 1. When the system recognizes, from an answer to a response request, that one or more other hardware-sets are again part of the process, system 10 will revert to originally set mode 2, or to originally set mode 3. Each hardware-set is able to invoke the above described default mode and recovery process logic, independently.

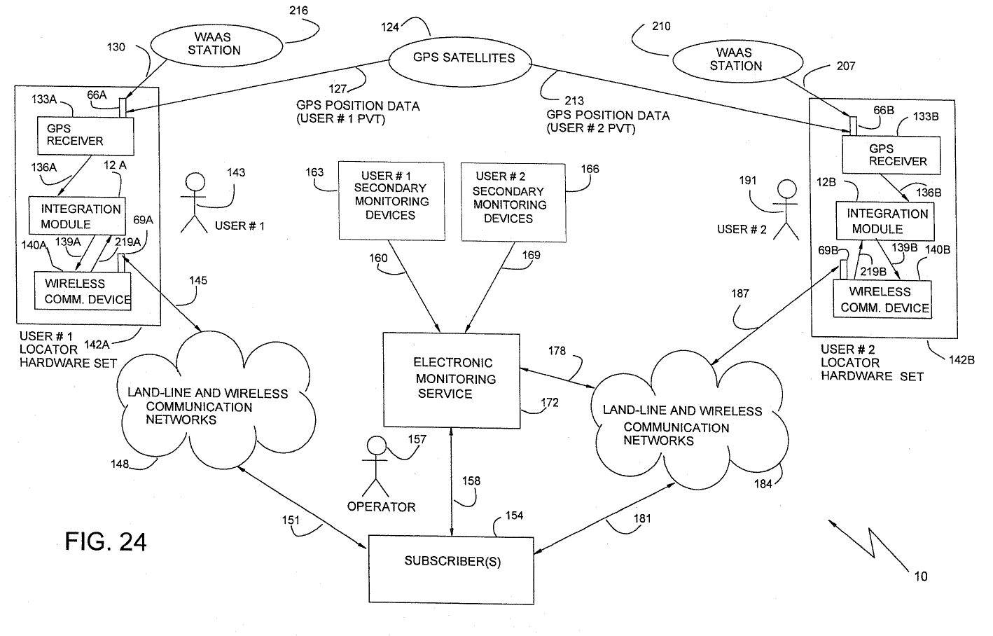

FIGS. 24-30 illustrate process flow alternative embodiments. Each user process flow is defined independently by subscriber 154. Each alternative process flow embodiment retains basic system 10 functionalities.

FIG. 24 illustrates a second process flow embodiment where a direct message link 175 from user 1 to EMS 172 is removed. Any messages from user 1's locator hardware set 142A will be routed to subscriber 154 and user 2's locator hardware set 142B as described in default and recovery process logic, above. In like manner, any messages from EMS to user 1's hardware-set 142A will be routed to subscriber 154 and routed through network 148 to user 1's hardware-set 142A through link 145.

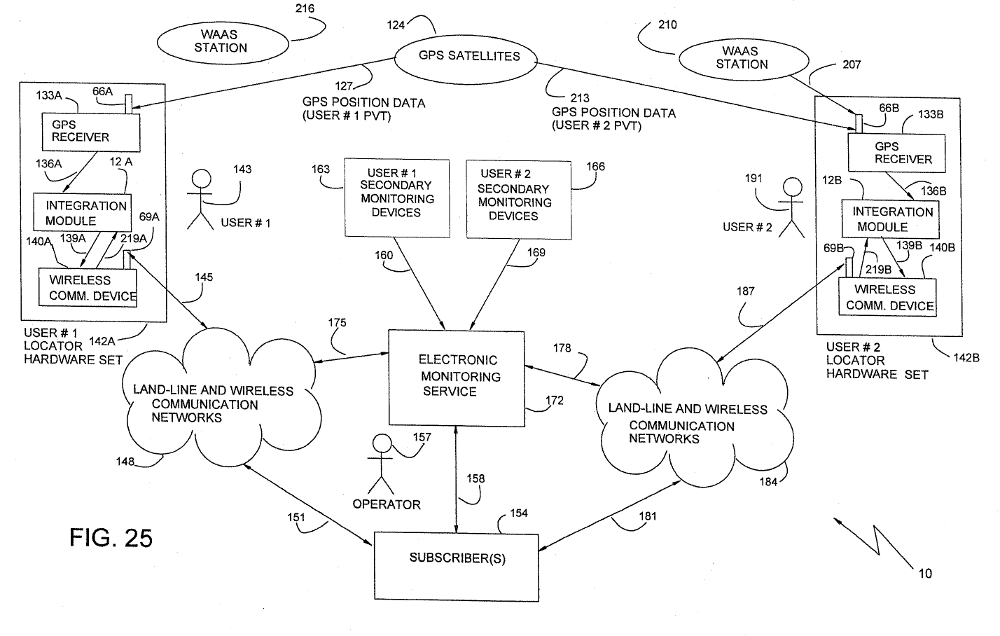

FIG. 25 illustrates a third process flow embodiment wherein WAAS correction data is not routed to locator set 142A via link 130. WAAS correction data is a refinement to the accuracy of GPS-generated PVT and is not required for system 10's basic functionality.

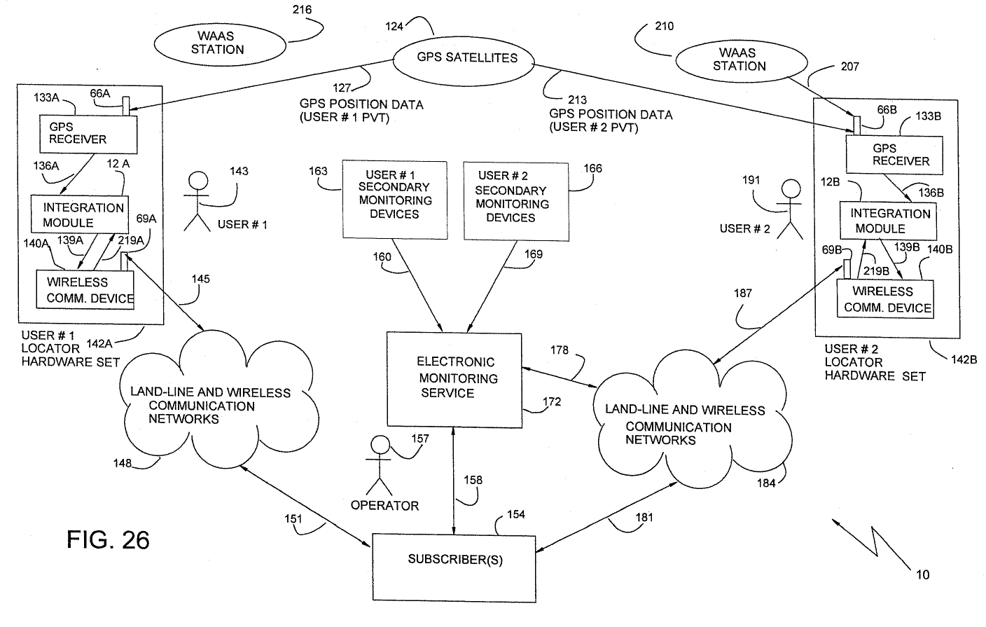

FIG. 26 illustrates a fourth process flow embodiment wherein WAAS data 130 and message link 175 have both been removed. System 10's default and recovery logic are invoked as described above, and basic functionality is maintained.

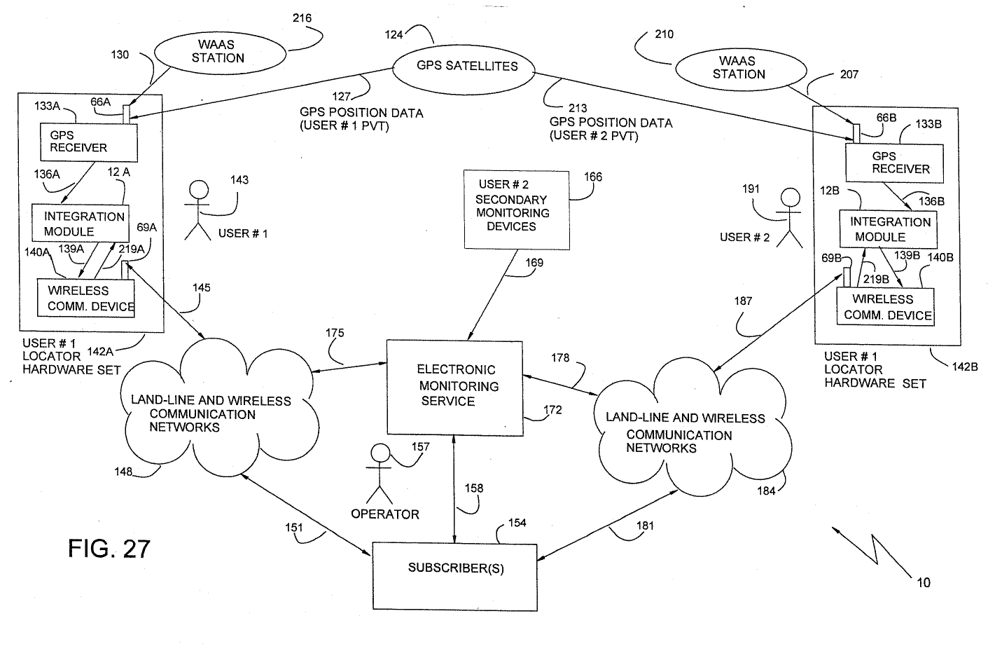

FIG. 27 illustrates fifth process flow embodiment wherein user 1's secondary monitoring devices 163 are removed. Data from secondary devices is informational, only, and do not contribute to basic functionality.

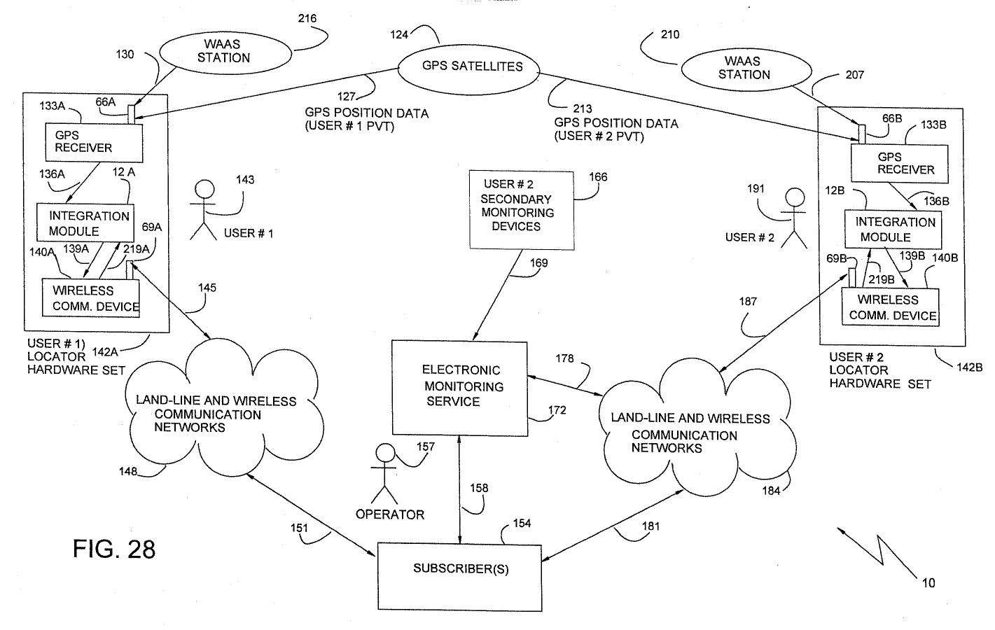

FIG. 28 illustrates a sixth embodiment wherein user 1's secondary monitoring devices 163 and direct link 175 are removed. System 10's default and recovery logic are invoked as described above and basic functionality is maintained.

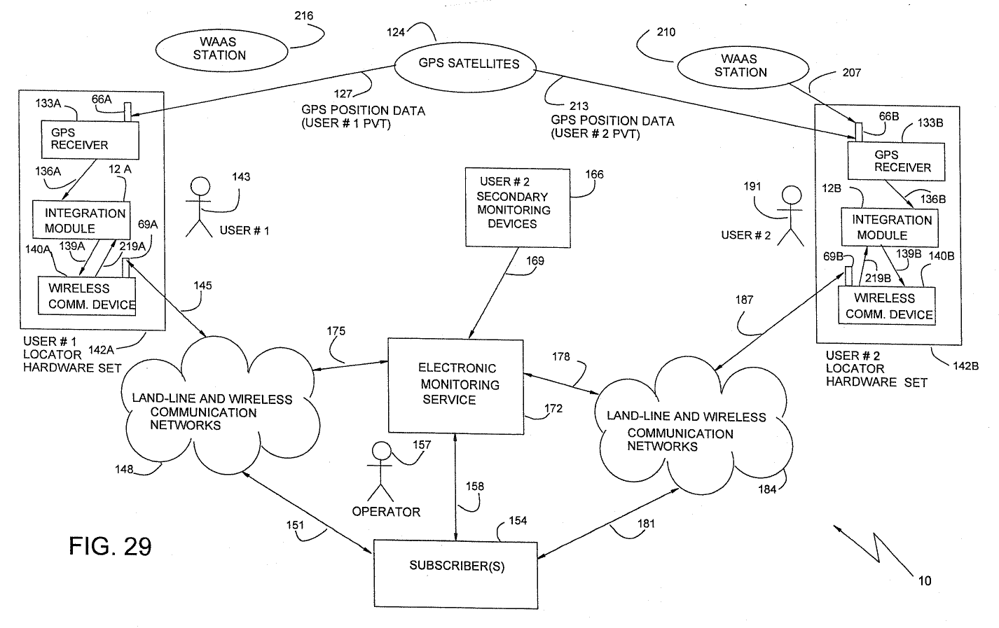

FIG. 29 shows a seventh embodiment where WAAS data 130 and user 1's secondary devices 163 are removed. Default and recovery logic are invoked as described, and functionality is maintained.

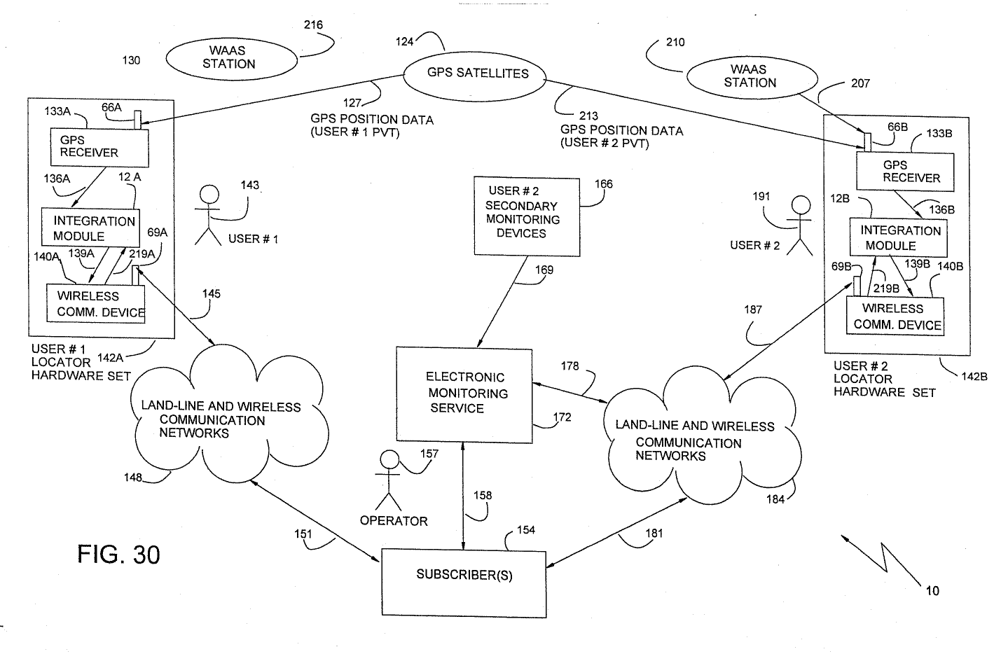

FIG. 30 illustrates an eighth embodiment with WAAS data 130, secondary devices 163 and direct link 175 removed. Default and recovery logic, as described above, are invoked to maintain functionality.

From the above description, it can be determined that the proximity activated location detection system of the present invention is able to overcome the shortcomings of prior art devices and systems. It can determine the location of and track, simultaneously, one or multiple persons or objects in both hostile and non-hostile circumstances by using the Global Positioning System of the United States, or compatible European and Asian location systems. Safe distance and close-time parameters are determined by subscribers and are used to activate the system when the distance between users or geographical locations are outside the limits set by the subscriber. In particular, it greatly increases the safety of victims in hostile circumstances by tracking a victim and an offender simultaneously, and calculating distance separating them and comparing that distance to safety parameters. In the circumstance where separation distances are outside safety parameters, the system places warning and informational telephone calls to appropriate destinations automatically. The simultaneous multiple-tracking function is also valuable in non-hostile situations, such as allowing several hikers to know when a hiker is too far from companions or a geographic location.

The present invention is configured by using a multiplicity of subscriber-determined values for operational parameters, which may be changed by subscribers via wireless communication. Furthermore, the system is simple for users to operate, requiring only that the hardware-sets be turned on in a standby mode and carried on their person or in their vehicle when they leave their residences or workplaces.

The present invention is economical in cost to manufacture, as all embodiments use standard wireless telephone circuitry and standard GPS receiver circuitry in conjunction with a relatively simple device to integrate the functions of wireless telephones and GPS receivers, in the form of Integration Module Assembly 12, or IMA circuit board 312.

It is understood that each of the elements described above, or two or more together may also find a useful application in other types of methods differing from the types described above.

While certain novel features of this invention are pointed out in the annexed claims, it is not intended to be limited to the details above, since it will be understood that various omissions, modifications, substitutions and changes in the forms and details of the devices illustrated and in operation can be made by those skilled in the art without departing in any way from the spirit of the present invention.

I claim:

1. A proximity-activated location detection system comprising:
a plurality of portable locator hardware sets, wherein each of the portable locator hardware set is associated with an identifiable person and programmed with a unique identifying number, wherein each portable locator hardware set may calculate a distance between a first location supplied by a present portable locator hardware set to a second location and compares a separation distance and close-time interval against predefined parameters, the present portable locator hardware set sending an alarm when the predefined parameters are violated.

2. A proximity-activated location detection system in accordance with claim 1, wherein each of the plurality of portable locator hardware sets comprises:
a wireless communication device having a transmitter and receiver;
a geographic locating device for determining a location of the present portable locator hardware set; and
a integration module assembly coupled to the wireless communication device and geographic locating device, the integration module assembly calculates the distance between the first location supplied by a present portable locator hardware set to a second location and compares the separation distance and close-time interval against predefined parameters.

3. A proximity-activated location detection system in accordance with claim 2, wherein the geographic locating device is a GPS receiver.

4. A proximity-activated location detection system in accordance with claim 3, wherein the GPS receiver uses a wide area augmentation system (WAAS).

5. A proximity-activated location detection system in accordance with claim 1, wherein the second location is provided by a second portable locator hardware set.

6. A proximity-activated location detection system in accordance with claim 1, further comprising a central monitoring device to monitor the geographic location of the plurality of portable hardware locator sets, wherein the central monitoring device may determine separation distance and close-time intervals between the plurality of portable locator hardware sets.

7. A proximity-activated location detection system in accordance with claim 6, wherein the central monitoring device increases a monitoring frequency of two specified portable locator hardware sets when the separation distance and close-time interval between the two specified portable locator hardware sets are not within safety parameter limits.

8. A proximity-activated location detection system in accordance with claim 1, wherein each of the plurality of portable locator hardware sets further comprises an alarm device coupled to the integration module to allow a user to send an alarm signal to predetermined destinations.

9. A proximity-activated location detection system in accordance with claim 8, wherein the alarm device sends the alarm signal to a central monitoring service.

10. A proximity-activated location detection system comprising:
a plurality of portable locator hardware sets, wherein each of the portable locator hardware set is associated with an identifiable person and programmed with a unique identifying number; and
means for calculating a distance between a first location supplied by a first portable locator hardware set to a second location supplied by a second portable locator set, for comparing a separation distance and close-time interval against predefined parameters and for sending an alarm when the predefined parameters are violated.

11. A proximity-activated location detection system in accordance with claim 10, wherein the means is located in each portable locator hardware set, each of the plurality of portable locator hardware sets comprising:
a wireless communication device having a transmitter and receiver;
a geographic locating device for determining a location of the present portable locator hardware set; and
a integration module assembly coupled to the wireless communication device and geographic locating device, the integration module assembly calculates the distance between the first location supplied by the first portable locator hardware set to the second location of the second portable locator hardware set and compares the separation distance and close-time interval against predefined parameters.

12. A proximity-activated location detection system in accordance with claim 10, wherein the means is a central monitoring service that monitors the first location supplied by the first portable locator hardware set and the second location of the second portable locator hardware set, compares the separation distance and close-time interval against predefined parameters and sending an alarm when the predefined parameters are violated.

13. A proximity-activated location detection system in accordance with claim 12, wherein the central monitoring service increases the monitoring frequency when the separation distance and close-time interval between are not within safety parameter limits.

14. A proximity-activated location detection system in accordance with claim 11, wherein each portable locator hardware set further comprises an alarm device coupled to the integration module to allow a user to send an alarm signal to predetermined destinations.

15. A method to determine when to alert an identifiable person of possible danger comprising:
providing a plurality of portable locator hardware sets, wherein each of the portable locator hardware set is associated with a specific person and programmed with a unique identifying number, wherein each of the plurality of portable locator hardware sets comprises:
a wireless communication device having a transmitter and receiver;
a geographic locating device for determining a location of the present portable locator hardware set; and
a integration module assembly coupled to the wireless communication device and geographic locating device, the integration module assembly calculates the distance between the first location supplied by a present portable locator hardware set to a second location of a second portable locator hardware set and compares the separation distance and close-time interval against predefined parameters;
providing a geographic location of the identifiable person using the geographic locating device of the portable locator hardware set associated with the identifiable person;
determining a separation distance and close-time interval between the geographic location of the identifiable person and a second person having a portable locator hardware set;
comparing the separation distance and close-time interval with predefined parameters; and
transmitting an alert to the identifiable person when the separation distance and close-time interval are not within predefined parameters.

16. The method of claim 15, wherein the geographic locating device is a GPS receiver.

17. The method of claim 16, wherein the GPS receiver uses a wide area augmentation system (WAAS).

18. The method of claim 15, further comprising transmitting the geographic location of the identifiable person to a central monitoring service.

19. The method of claim 18, wherein the central monitoring service determines the separation distance and close-interval between the geographic location of the identifiable person and a second person having a portable locator hardware set, compares the separation distance and close-time interval with predefined parameters, and transmits the alert to the identifiable person when the separation distance and close-time interval are not within predefined parameters.

20. The method of claim 19, further comprising increasing monitoring frequency by the central monitoring service increases when the calculated separation distance and close-time interval are not within predefined parameters.
